(19) United States
(12) Patent Application Publication
(10) Pub. No.: US 2025/0075080 A1
(43) Pub. Date: Mar. 6, 2025

(54) PROCESS FOR THE PRODUCTION OF FLAKE-FORM, CRYSTALLINE PARTICLES HAVING AN AURIVILLIUS STRUCTURE AND THE USE THEREOF AS EFFECT PIGMENTS OR SUBSTRATES THEREOF

(71) Applicant: Merck Patent GmbH, Darmstadt (DE)

(72) Inventors: Christoph Schmidt, Darmstadt (DE); Carsten Handrosch, Darmstadt (DE); Tanja Delp, Darmstadt (DE); Andrea Heyland, Darmstadt (DE); Johann Bauer, Darmstadt (DE)

(73) Assignee: Merck Patent GmbH, Darmstadt (DE)

(21) Appl. No.: 18/557,706

(22) PCT Filed: Apr. 28, 2022
(86) PCT No.: PCT/EP2022/061291

§ 371 Date: Oct. 27, 2023

(30) Foreign Application Priority Data
Apr. 30, 2021 (EP) 21171454.8

(51) Int. Cl. C09C 1/00

(52) U.S. Cl. CPC C09C 1/0018; C09C 1/0039; C09C 2200/1004; C09C 2200/1087

(57) ABSTRACT

A process for the production of flake-form, crystalline particles having an aurivillius structure, the use thereof as effect pigments or as substrates of effect pigments, furthermore, effect pigments which contain coated or uncoated flake-form, crystalline particles having an aurivillius structure as substrates, and the use thereof in various products.

The present invention relates to the production of flake-form, crystalline particles having an aurivillius structure, to the use thereof as effect pigments or as substrates of effect pigments, furthermore to effect pigments which contain coated or uncoated flake-form, crystalline particles having an aurivillius structure as substrates, and to the use thereof.

Crystals of the so-called aurivillius phases grow in flake form owing to the particular layer structure. Some of these compounds additionally have a high refractive index n. The most important representative of this class of substances is bismuth titanate Bi₄Ti₃O₁₂. Further examples are Bi₅Ti₃FeO₁₅ and Bi₂WO₅.

The aurivillius phase denotes a form of perovskite of the generic formula (Bi₂O₂)(Aₙ₋₁BₙO₃ₙ₊₁), where A denotes a large, twelve-fold-coordinated cation and B denotes a small, six-fold-coordinated cation. The structure of aurivillius phases is basically formed by alternating layers of [Bi₂O₂]²⁺ and pseudo-perovskite blocks, where the perovskite layers have n octahedrally coordinated layers.

Bi₄Ti₃O₁₂ and other members of the aurivillius series have been of interest in materials research for some years owing to their particular electrical properties, since they are ferroelectric and piezoelectric. They are consequently in principle suitable for the production of electronic components, such as capacitors or sensors. In addition, they have catalytic properties.

The preferred route for the production of BIT particles starts from bismuth oxide, Bi₂O₃, and titanium dioxide, TiO₂. These two starting compounds are typically mixed with salts, such as halides or sulfates of alkali metals, e.g. KCl, NaCl, KBr, NaBr, Na₂SO₄, K₂SO₄ or mixtures thereof and heated at temperatures of 800-950° C. for several hours.

According to the prior art, on use of the chloride salt matrix small BIT flakes having a diameter of up to about 15 μm form, while on use of sulfates very small flakes and/or particles of undefined shape are obtained (<3 μm). However, such particles are too small and, with respect to the shape, not suitable for generating interesting optical effects.

However, the advantage of the chloride matrix for relatively large particles is countered by a high chemical load of the production plants, since alkali metal chlorides have a high evaporation rate at the high process temperatures that are necessary. The chloride vapours have a very strongly corrosive action on the production plant, meaning that economic operation is highly doubtful. In addition, the reproducibility in relation to the size and thickness of the crystal flakes is unsatisfactory according to the prior art.

There is therefore a need for a production process which does not have the disadvantages of the prior art, and in particular enables the production of relatively large particles without an excessive load on the production plant.

Transparent flake-form materials having a high refractive index n have already been utilised for some time as effect pigments, e.g. basic lead carbonate (n=2.0) and bismuth oxychloride (n=2.15). Whereas basic lead carbonate is no longer used owing to its toxicity, bismuth oxychloride is widely used, in particular as cosmetic colourant.

However, it is desirable to have further effect pigments available.

The object of the invention is to provide a process for the production of crystalline particles having an aurivillius structure and novel effect pigments having flake-form substrates.

This object is achieved in accordance with the invention by a process as described and claimed below, in particular having the features of Claims 1-11, and by effect pigments having the features of Claims 12-16.

In particular, the present application relates to a process for the preparation of crystalline compounds having an aurivillius structure, in which the starting materials, preferably a bismuth oxide and a titanium oxide, and optionally a further oxide, in particular a transition-metal oxide, particularly preferably an iron oxide, are mixed with a salt mixture comprising NaCl and Na₂SO₄ and preferably one or more assistants to give a homogenised salt matrix/oxide mixture and are heated to 800-1200° C.

In the process according to the invention, Bi₂₀₃, TiO₂ and optionally a further oxide, in particular a transition-metal oxide, particularly preferably an iron oxide, are preferably mixed with a salt mixture comprising NaCl and Na₂SO₄ and preferably one or more assistants to give a homogenised salt matrix/oxide mixture and heated at 800-1200° C.

Surprisingly, it has been found that the process in accordance with the present application enables large bismuth titanate flakes to be obtained. The starting materials are reacted in a salt matrix mixture of NaCl and Na₂SO₄. The mass ratio of NaCl to Na₂SO₄ is preferably 55-70:45-30, particularly preferably 55-65:45-35. A eutectic mixture of NaCl and Na₂SO₄ is particularly preferably employed.

The salt mixture preferably comprises an assistant, preferably in an amount of 1-10 mol %, in particular of 1-6 mol %, e.g. 1-2 mol % or 5 mol %, based on the amount of TiO₂ employed. Preferred assistants are Na₂CO₃, K₂CO₃, CaCO₃, CaO, CaCl₂, Na₄P₂O₇ and KBr, particularly preferably Na₂CO₃, Na₄P₂O₇ and KBr. A large part of the chlorides in these mixtures has been replaced by sodium sulfate. This significantly lowers the vapour pressure of the chlorides. This can easily be recognised from the amount of NaCl precipitated on the crucible lid.

In addition, an unexpectedly large reduction in the vapour pressure of the NaCl by the admixing of the Na₂SO₄ can be observed. A greater corrosion-reducing effect by the Na₂SO₄ fraction can consequently be assumed than would be expected from the pure amount fraction.

The reaction can basically take place at temperatures of 800-1200° C., preferably of 700-1100° C., particularly preferably of 800-1050° C. The reactants are usually heated at these temperatures for several hours, preferably 2-10 h.

In a preferred embodiment, the process according to the invention comprises the following steps:

1. Heating of the starting materials with the salt mixture and the optional assistants from room temperature to a temperature of 800-1200° C., preferably of 700-1100° C., particularly preferably of 800-1050° C., preferably over the course of 3-4 h.

2. Holding of the reaction mixture at the temperature indicated in step 1, preferably for 2-6 h.

3. Cooling of the reaction mixture to room temperature, preferably over the course of >7 h, e.g. by natural cooling.

As starting materials, the corresponding oxides on which the desired products are based are mixed with the salt matrix mixture and the assistants and thermally treated as described. For example, Bi₂₀₃ and TiO₂ are employed for the preparation of Bi₄Ti₃O₁₂ and Bi₂₀₃, TiO₂ and Fe₂O₃ are used for the preparation of Bi₅Ti₃FeO₁₅.

The preparation is preferably carried out in suitable ceramic crucibles, e.g. made from Al₂O₃. After the heating and cooling, the particles obtained can be detached from the crucible, e.g. with water, filtered off, washed with water and dried.

In a variant of the process according to the invention, moulded pieces having a high oxide content of Bi₂O₃ and TiO₂, preferably 7-50% by weight, particularly preferably 7-14% by weight, are pressed from a homogenised salt matrix/oxide mixture. Preferably, these are then calcined resting on corundum beads in ceramic crucibles. Due to the high product content, the pressed pieces retain their shape and the hot salts do not touch the crucible.

This process variant avoids the problems of the production processes known to date, such as the low stability of available crucible materials to the hot salt melt containing bismuth oxide. Bi₂O₃ penetrates through virtually all oxides known for crucibles and very greatly shortens their service life by causing fissures and cracks. In addition, bismuth is a known “platinum poison”, which means that using platinum crucibles also cannot come into consideration for commercial production.

The comments made here for Bi₄Ti₃O₁₂ also apply in a comparable manner to other compounds of the aurivillius type (see Dalton Trans., 2015, 44, 20568) having the general formula [Bi₂O₂]²⁺[Aₙ₋₁BₙO₃ₙ₊₁]²⁻, where A denotes a large, twelve-fold-coordinated cation and B denotes a small, six-fold-coordinated cation. These compounds are built up from alternating layers of a perovskite-like block having n layers (n=1−∞) and B cations coordinated octahedrally by oxide and layers of (Bi₂O₂)²⁺ with oxide in a quadratic planar arrangement with Bi³⁺ directed alternately upward and downward.

The invention furthermore relates to effect pigments which comprise, as substrates, coated or uncoated flake-form, crystalline particles having an aurivillius structure, in particular in which the flake-form, crystalline particles having an aurivillius structure are produced by a process as described above and below.

Above and below, the term “substrate(s)” stands, unless indicated otherwise, for the flake-form, crystalline particles having an aurivillius structure.

Preferred substrates are titanates, in particular Bi₄Ti₃O₁₂ or Bi₅Ti₃FeO₁₅, in particular Bi₄Ti₃O₁₂.

The flake-form particles of the invention can be obtainable and used with various optical properties, from matt to glossy and from transparent to opaque.

In general, the flake-form particles have a thickness between 0.02 and 5 μm, in particular between 0.05 and 4.5 μm, preferably between 0.05 and 2 μm, particularly preferably between 0.05 and 1 μm, very particularly preferably between 0.1 and 0.5 μm.

The size of the flake-form particles is not crucial per se and can be matched to the respective application. The particle size is usually 0.5-50 μm, preferably 1-35 μm, particularly preferably 2-25 μm. It is preferably also possible to employ substrate mixtures consisting of flakes having different particle sizes.

The particle sizes are determined by means of laser diffraction on the powder or on pigment suspensions using commercially available instruments known to the person skilled in the art (e.g. from Malvern, Horiba).

The flake-form particles preferably have an aspect ratio (diameter/thickness ratio) of 5-120, in particular of 10-70 and very particularly preferably of 25-50.

The flake-form particles may be coated on one or more sides with one or more transparent, semitransparent and/or opaque layers comprising metal oxides, metal oxide hydrates, metal suboxides, metals, metal fluorides, metal nitrides, metal oxynitrides or mixtures of these materials. The substrate is preferably surrounded by these layers. The metal oxide, metal oxide hydrate, metal suboxide, metal, metal fluoride, metal nitride, metal oxynitride layers or the mixtures thereof can be of low refractive index (refractive index <1.8) or high refractive index (refractive index ≥1.8, preferably ≥2.0.). Suitable metal oxides and metal oxide hydrates are all metal oxides or metal oxide hydrates known to the person skilled in the art, such as, for example, aluminium oxide, aluminium oxide hydrate, silicon oxide, silicon oxide hydrate, iron oxide, tin oxide, cerium oxide, zinc oxide, zirconium oxide, chromium oxide, titanium oxide, in particular titanium dioxide, in the rutile or anatase modification, titanium oxide hydrate and mixtures thereof, such as, for example, ilmenite or pseudobrookite. Metal suboxides which can be employed are, for example, the titanium suboxides. Suitable metals are, for example, chromium, aluminium, nickel, silver, gold, titanium, copper or alloys, a suitable metal fluoride is, for example, magnesium fluoride. Metal nitrides or metal oxynitrides which can be employed are, for example, the nitrides or oxynitrides of the metals titanium, zirconium and/or tantalum. Metal oxide, metal, metal fluoride and/or metal oxide hydrate layers are preferably applied to the substrate and metal oxide and/or metal oxide hydrate layers are very particularly preferably applied.

Particular preference is given to oxides and/or oxide hydrates of aluminium, silicon, iron, tin or titanium, in particular titanium dioxide, in the rutile or anatase modification, preferably in the rutile modification, and mixtures of these compounds. In order to convert titanium dioxide into the rutile modification, a tin dioxide layer is usually applied beneath a titanium dioxide layer. The effect pigments according to the invention may thus also contain a tin dioxide between substrate and outer coating in order to convert the titanium dioxide present in the outer coating that is essential to the invention into the rutile modification. Furthermore, multilayered systems comprising high- and low-refractive-index metal oxide, metal oxide hydrate, metal or metal fluoride layers may also be present, with high- and low-refractive-index layers preferably alternating. Particular preference is given to layer packages comprising a high-refractive-index layer (refractive index ≥2.0) and a low-refractive-index layer (refractive index ≤1.8), where one or more of these layer packages may be applied to the substrate. The sequence of the high- and low-refractive-index layers can be adapted to the substrate in order to include the substrate in the multilayered system. In a further embodiment, the metal oxide, metal oxide hydrate, metal suboxide, metal, metal fluoride, metal nitride, metal oxynitride layers may be mixed or doped with colourants or other elements. Suitable colourants or other elements are, for example, organic or inorganic coloured pigments, such as coloured metal oxides, e.g. magnetite, chromium oxide or coloured pigments such as, for example, Berlin Blue, ultramarine, bismuth vanadate, Thenard's Blue, or alternatively organic coloured pigments, such as, for example, indigo, azo pigments, phthalocyanines or also Carmine Red, or elements such as, for example, yttrium or antimony. Effect pigments comprising these layers exhibit great colour variety in relation to their mass tone and may in many cases exhibit an angle-dependent change in the colour (colour flop) due to interference.

The layers of metal oxides, hydroxide and/or oxide hydrates are preferably applied by wet-chemical methods, it being possible to use the wet-chemical coating methods that were developed for the production of effect pigments, which lead to surrounding of the substrate.

The coating of the flake-form particles with one or more metal oxides can be carried out, for example, as described in WO 93/08237 (wet-chemical coating) or DE-A 196 14 637 (CVD process) or also in further patent documents and other publications known to the person skilled in the art.

The thickness of the individual layers on the substrate is, as familiar to the person skilled in the art, essential for the optical properties of the pigment. The thickness of the metal oxide, metal oxide hydrate, metal suboxide, metal, metal fluoride, metal nitride, metal oxynitride layers or mixtures thereof is usually 10 to 1000 nm, preferably 15 to 800 nm, in particular 20 to 600 nm. Layer thicknesses of 20 to 200 nm are particularly suitable. The thickness of the metal layers is preferably 4 to 50 nm.

The effect pigments of the invention may have organic and/or inorganic coatings as stabilisation layers on the substrate or on the outer metal oxide layer, as described, for example, in EP 1 661 952, DE 43 05 280.

The effect pigments according to the invention can be used in a very wide variety of ways, e.g. in products selected from paints, coatings, automobile paints, powder coatings, printing inks, security printing inks, plastics, ceramic materials, glasses, paper, paper coatings, toners for electrophotographic printing processes, seed, greenhouse sheeting, tarpaulins, absorbers for the laser marking of paper and plastics, absorbers in the laser welding of plastics, cosmetic formulations, in pigment pastes, pigment preparations and dry preparations. Products of this type are prepared in a manner as is known to the person skilled in the art in this field.

The effect pigments according to the invention can preferably be used, for example, in lipsticks, lip gloss, rouge, eyeliner, eye shadows, (volume) mascara, nail varnishes, day creams, night creams, body lotions, cleansing milk, body powders, sticks, hair gels, hair masks, hair dyes, hair rinses, hair shampoos, shower gels, shower preparations, shower oils, bath additives, sun protection, pre-sun and after-sun preparations, tanning lotions, tanning sprays, rouge, make-ups, care creams, lotions, soaps, bath salts, toothpaste, face masks, compact powders, loose powders and gels, etc. Products of this type are prepared in a manner as is known to the person skilled in the art in this field.

It goes without saying that, for the various applications, the effect pigments according to the invention can also advantageously be used in a blend with other effect pigments, such as, for example, pearlescent pigments, interference pigments, goniochromatic pigments, BiOCl flakes, multilayered pigments, metal pigments, organic dyes, organic coloured pigments and other pigments, such as, for example, transparent and opaque white, coloured and black pigments, and with flake-form iron oxides, holographic pigments, LCPs (liquid crystal polymers) and conventional transparent, coloured and black lustre pigments based on metal oxide-coated mica and SiO₂ flakes, etc. The effect pigments according to the invention can be mixed in any ratio with commercially available (effect) pigments.

Even without further comments, it will be assumed that a person skilled in the art will be able to utilise the above description in the broadest scope. The preferred embodiments and examples should therefore merely be regarded as descriptive disclosure which is absolutely not limiting in any way. All starting components are either commercially available or can be synthesised by known methods. The amounts indicated in the description and in the examples for the constituents in the compositions always add up to a total of 100%.

The following abbreviations are used below: RT=room temperature, DI water=deionised water

### EXAMPLE 1—PRODUCTION OF Bi₄Ti₃O₁₂ FLAKES FROM SALT MELT

0.8 g of Bi₂O₃, 0.2 g of TiO₂, 0.01 g of Na₂CO₃ and 8.4 g/5.5 g of NaCl/Na₂SO₄ (eutectic mixture) are weighed out in a can (60 ml), mixed in a Speedmixer at 1000 rpm for 1 min and subsequently ground 3×5s in in a blade mill (SEVERIN KM3868; 140 W).

15 g of the ground mixture are weighed out in an aluminium oxide crucible. The crucible is covered with an aluminium oxide lid and heated and cooled in an oven (Heraeus Thermicon P) in accordance with the following program:
1. From 25° C. to 1005° C. in 4.5 h;
2. At 1005° C. for 4 h;
3. From 1005° C. to 150° C. in 7 h.

After cooling to room temperature, the crucible with the salt melt is stirred for about 2 h in 11 of deionised water at 50° C. and 200 rpm. The contents (detached from the crucible) are filtered, washed with 11 of deionised water and dried at 110° C. for 12 h. Yield: 0.8 g (78%).

SEM photomicrographs show the flake-form structure. The aurivillius crystal structure is confirmed by x-ray structural analysis.

### EXAMPLE 2—PRODUCTION OF Bi₅Ti₃FeO₁₅ FLAKES FROM SALT PELLETS

2.5 g of Bi₂O₃ nanopowder 90-120 (Sigma-Aldrich 637017-250G), 0.64 g of TiO₂ 1002 (KRONOS), 0.04 g of Na₂CO₃ (Merck 1.06392.1000), 7.2 g of NaCl (Sigma Aldrich S5886-5 kg) and 4.7 g of Na₂SO₄ (Merck 1.06645.2500) are mixed in a Speedmixer at 1000 rpm for 1 min. and homogenised 3 times for 5 sec. in a blade mill (SEVERIN KM3868; 140 W). In each case, 2.2 g of the mixture are pressed in a hydraulic press at a pressure of 1.9 t/cm² to give seven pressed discs having a diameter of 1.3 cm. The bottom of an aluminium oxide crucible (GTS CCM 0070-AC AL99-G; 153 ml) is covered with aluminium oxide beads and the seven pressed discs are distributed thereon. The crucible is closed with an aluminium oxide lid, calcined at 1000° C. for 4 h and allowed to cool slowly to below 50° in the oven over a period of about 7 h. The crucible is subsequently treated in warm deionised water at 50° C. with gentle stirring until the salt matrix has completely dissolved (about 2 hours). The finely divided Bi₄Ti₃O₁₂ is then filtered off, washed with deionised water and dried at 110° C. for about 12 h.

About 2.9 g of Bi₄Ti₃O₁₂ having a mother-of-pearl-like lustre are obtained.

### EXAMPLE 3—PRODUCTION OF A MONOLAYER EFFECT PIGMENT COMPRISING Bi₄Ti₃O₁₂ FLAKES WITH SnO₂ AND TiO₂ COATING

75 g of bismuth titanate flakes (Bi₄Ti₃O₁₂) are suspended in 7501 of deionised water and heated to 75° C. with stirring at 500 rpm. The suspension is adjusted to pH1.8 by addition of HCl (5%) and stirred for a further 15 min.

### Sno₂ Coating:

An aqueous solution of SnCl₄ (50%) and HCl (37%) is metered into the suspension until the desired proportion of TiO₂ has been reached, with the pH being kept at pH 1.8 by addition of dilute sodium hydroxide solution, and the mixture is subsequently stirred for a further 15 min.

### Tio₂ Coating:

An aqueous solution of TiCl₄ (25%) and HCl (25%) is metered into the suspension until the desired proportion of TiO₂ has been reached, with the pH being kept at pH 1.8 by addition of dilute sodium hydroxide solution.

The pH of the suspension is adjusted to pH 5.0, the pigment is subsequently filtered off, washed, dried at 110° C. for 12 h and calcined at 850° C. for 30 min.

Coated pigments with SnO₂ and various proportions of TiO₂ based on the bismuth titanate flakes, are prepared as indicated in Table 1.

TABLE 1

| Sample | Coating | Amount (%)* |
|---|---|---|
| 5.0** | SnO₂ | 1.3 |
| 5.1 | TiO₂ | 13 |
| 5.2 | TiO₂ | 18 |
| 5.3 | TiO₂ | 23 |
| 5.4 | TiO₂ | 27 |
| 5.5 | TiO₂ | 31 |
| 5.6 | TiO₂ | 40 |
| 5.7 | TiO₂ | 51 |

*based on bismuth titanate flakes
**the flakes with SnO₂ coating are used further directly for the respective subsequent TiO₂ coating

The layer structure of the pigments (SnO₂/TiO₂ monolayer) is evident in SEM photomicrographs.

### EXAMPLE 4—PRODUCTION OF A MULTILAYER EFFECT PIGMENT COMPRISING Bi₄Ti₃O₁₂ FLAKES WITH A TiO₂ AND Fi₂O₃ COATING

75 g of bismuth titanate flakes (Bi₄Ti₃O₁₂) are suspended in 7501 of deionised water and heated to 75° C. with stirring at 500 rpm. The suspension is adjusted to pH1.8 by addition of HCl (5%) and stirred for a further 15 min.

### Tio₂ Coating:

An aqueous solution of TiCl₄ (10%) is metered into the suspension until the desired proportion of TiO₂ has been reached, with the pH being kept at pH 1.8 by addition of dilute sodium hydroxide solution, and the mixture is subsequently stirred for a further 15 min.

Fe₂O₃ Coating:

The pH of the suspension is adjusted to pH 2.8, an aqueous solution of FeCl₃ (3.5%) is subsequently metered in until the desired proportion of Fe₂O₃ has been reached, with the pH being kept at pH 2.8 by addition of dilute sodium hydroxide solution.

The pH of the suspension is adjusted to pH 5.0, the pigment is subsequently filtered off, washed, dried at 110° C. for 12 h and calcined at 850° C. for 30 min and at 50° C. for 30 min.

Coated pigments having various proportions of TiO₂ and Fe₂O₃, based on the bismuth titanate flakes, are prepared as indicated in Table 2.

TABLE 2

| Sample | Coating 1 | Amount (%)* | Coating 2 | Amount (%)* |
|---|---|---|---|---|
| 6.1 | TiO₂ | 5 | Fe₂O₃ | 15 |
| 6.2 | TiO₂ | 5 | Fe₂O₃ | 20 |
| 6.3 | TiO₂ | 5 | Fe₂O₃ | 25 |
| 6.4 | TiO₂ | 5 | Fe₂O₃ | 30 |
| 6.5 | TiO₂ | 5 | Fe₂O₃ | 35 |
| 6.6 | TiO₂ | 5 | Fe₂O₃ | 40 |

*based on bismuth titanate flakes

The layer structure of the pigments (TiO₂/Fe₂O₃ bilayer) is evident in SEM photomicrographs.

1. A process for the preparation of crystalline compounds having an aurivillius structure, in which the starting compounds are mixed with a salt mixture comprising NaCl and Na₂SO₄ and optionally one or more assistants to give a homogenised salt matrix/oxide mixture and are heated at 800-1200° C.

2. The process according to claim 1, in which Bi₂O₃, TiO₂, and optionally a further oxide are mixed with a salt mixture comprising NaCl and Na₂SO₄ and optionally one or more assistants to give a homogenised salt matrix/oxide mixture and are heated at 800-1200° C.

3. The process according to claim 2, wherein the further oxide used is Fe₂O₃.

4. The process according to claim 1, wherein the assistants used are one or more salts selected from the group consisting of Na₂CO₃, K₂CO₃, CaCO₃, CaO, CaCl₂, Na₄P₂O₇ and KBr.

5. The process according to claim 1, wherein the salt mixture comprises assistants in an amount of 1-10 mol % of the amount of TiO₂ employed.

6. The process according to claim 1, wherein the homogenised salt matrix/oxide mixture comprises 7-50% by weight of Bi₂O₃ and TiO₂.

7. The process according to claim 1, wherein the homogenised salt matrix/oxide mixture is pressed to give moulded pieces.

8. The process according to claim 7, wherein the moulded pieces are calcined in ceramic crucibles.

9. The process according to claim 8, wherein the moulded pieces are calcined resting on corundum beads in ceramic crucibles.

10. The process according to claim 1, wherein the compound prepared is Bi₄Ti₃O₁₂.

11. The process according to claim 1, wherein the compound prepared is Bi₅Ti₃FeO₁₅.

12. An effect pigments comprising coated or uncoated flake-form crystalline particles having an aurivillius structure.

13. The effect pigments according to claim 12, wherein the flake-form crystalline particles having an aurivillius structure comprise Bi₄Ti₃O₁₂ or Bi₅Ti₃FeO₁₅.

14. The effect pigment according to claim 12, wherein the flake-form crystalline particles having an aurivillius structure are coated with one or more layers of oxides and/or oxide hydrates of aluminium, silicon, iron, zinc, zirconium, tin and titanium, and/or mixtures of these compounds.

15. The effect pigments according to claim 14, wherein one or more organic and/or inorganic stabilisation layers have been applied to the flake-form crystalline particles having an aurivillius structure or to the outer metal oxide layer.

16. An effect pigments comprising coated or uncoated flake-form crystalline particles having an aurivillius structure, wherein the flake-form crystalline particles having an aurivillius structure are produced by a process in which the starting compounds are mixed with a salt mixture comprising NaCl and Na₂SO₄ and optionally one or more assistants to give a homogenised salt matrix/oxide mixture and are heated at 800-1200° C.

17. A product selected from paints, coatings, automobile paints, powder coatings, printing inks, security printing inks, plastics, ceramic materials, glasses, paper, paper coatings, toners for electrophotographic printing processes, seed, greenhouse sheeting, tarpaulins, absorbers for the laser marking of paper and plastics, absorbers in the laser welding of plastics, cosmetic formulations, pigment pastes, pigment preparations and dry preparations, said product comprising an effect pigment comprising coated or uncoated flake-form crystalline particles having an aurivillius structure.
